(19) United States
(12) Patent Application Publication
(10) Pub. No.: US 2020/0012727 A1
(43) Pub. Date: Jan. 9, 2020

(54) ORGANIZING OBJECTS IN A FEED TO FACILITATE INTERACTION BETWEEN FANS AND CONTENT OWNERS

(71) Applicant: GOOGLE INC., Mountain View, CA (US)

(72) Inventors: JUSTIN LEWIS, MARINA DEL REY, CA (US); JEFFREY LEE CHAN, VENICE, CA (US)

(21) Appl. No.: 14/622,612

(22) Filed: Feb. 13, 2015

Related U.S. Application Data
(60) Provisional application No. 61/941,477, filed on Feb. 18, 2014.

(51) Int. Cl. G06F 17/30

(52) U.S. Cl. CPC G06F 17/3053

(57) ABSTRACT

Providing objects in a feed is described. A computing device identifies activities of fans of content of a content owner. The activities are associated with objects pertaining to the content of the content owner. The computing device creates a feed that includes at least a subset of the objects pertaining to the content of the content owner for presentation to the content owner.

### RELATED APPLICATION

This application is related to and claims the benefit of U.S. Patent Application No. 61/941,477, filed Feb. 18, 2014, the entirety of which is incorporated herein by reference.

### TECHNICAL FIELD

Embodiments of the present disclosure relate to multimedia content and, more particularly, to ranking objects in a feed.

### BACKGROUND

On the Internet, social networks allow users to connect to and share information with each other. Many social networks include a content sharing aspect that allow users to upload, view, and share content, such as video content, image content, audio content, and so on. Other users of the social network may comment on the shared content, discover new content, locate updates, share content, and otherwise interact with the provided content. The shared content may include content from professional content creators, e.g., movie clips, TV clips, and music videos, as well as content from amateur content creators, e.g., video blogging and short original videos.

### SUMMARY

In one aspect, a method includes identifying a plurality of fans of content of a content owner. The method further includes identifying activities of the plurality of fans. The activities are associated with a plurality of social shares pertaining to the content of the content owner. The method further includes creating, by a processing device, a feed that includes at least a subset of the plurality of social shares pertaining to the content of the content owner for presentation to the content owner, the subset includes two or more social shares.

In additional aspects, computing devices for performing the operations of the above described embodiments are also implemented. Additionally, in embodiments of the disclosure, a computer readable storage media stores methods for performing the operations of the above described embodiments.

### BRIEF DESCRIPTION OF THE DRAWINGS

The present disclosure will be understood more fully from the detailed description given below and from the accompanying drawings of various implementations of the disclosure.

FIG. 1 illustrates an example system architecture, in accordance with one implementation of the present disclosure.

FIG. 2 is a flow diagram illustrating a method for creating a feed of objects, according to some implementations of the disclosure.

FIG. 3 is a flow diagram illustrating a method for ranking objects associated with a content owner, according to some implementations of the disclosure.

FIG. 4 is a flow diagram illustrating a method for presenting objects on a client device, according to some implementations of the disclosure.

FIGS. 5A-C are example user interfaces in accordance with implementations of the present disclosure.

FIG. 6 is a block diagram of an example computer system that may perform one or more of the operations described herein.

### DETAILED DESCRIPTION

Described herein are systems and methods that enable a content owner to engage with fans of their content. A fan is a user who indicates interest in content of another user such as a content owner by, for example, indicating approval of the content (“liking” the content), providing feedback (e.g., comments) for the content, subscribing to the content, and the like. A content owner can be an individual or an entity that owns, licenses, or otherwise has authorization to make content available to others. Conventional content sharing services allow a content owner to share content (e.g., video, music, documents, blog, etc.), such as in a social share (e.g., post, feed item). A social share refers to information (e.g., post, feed item) resulting from a user sharing a content item (e.g., via a share request) on a social network or a content sharing service. Other users, referred to herein as “fans,” can engage with the content shared by the content owner, such as by viewing, liking, commenting and subscribing to the content. Conventional content sharing services typically do little to drive interaction between the content owner and fans of the content owner's content.

Currently, a content sharing platform may present to a content owner a list (e.g., activity feed, news feed, stream, wall, etc.) of objects (e.g., posts, media items such as video, images, audio, etc., status updates, favorability indications, tags, messages, and so on) that are associated with content of the content owner. The content sharing platform may rank these objects in the listing chronologically, but such lists often make it difficult for a content owner to identify ways to interact with their fans. This problem is compounded when the list includes objects from multiple sources (e.g., social networks, video platforms, etc.). Conventional techniques do not present the objects to the content owner in a manner that assists the content owner in interacting with the fans.

Aspects of the present disclosure address the above deficiencies of conventional systems by organizing objects and presenting the objects in a feed in a manner that facilitates interaction between fans and the content owner. A content sharing platform can identify the fans of content of the content owner. The content sharing platform can identify activities of the fans as they relate to objects that are associated with content of the content owner. The content sharing platform can create a feed that includes at least a subset of the objects pertaining to the content of the content owner for presentation to the content owner. In implementations, the content sharing platform can rank the objects and present the objects in the feed according to their respective ranks. A content owner can use the feed to quickly identify fan activity, which helps drive greater interaction between content owners and fans of their content.

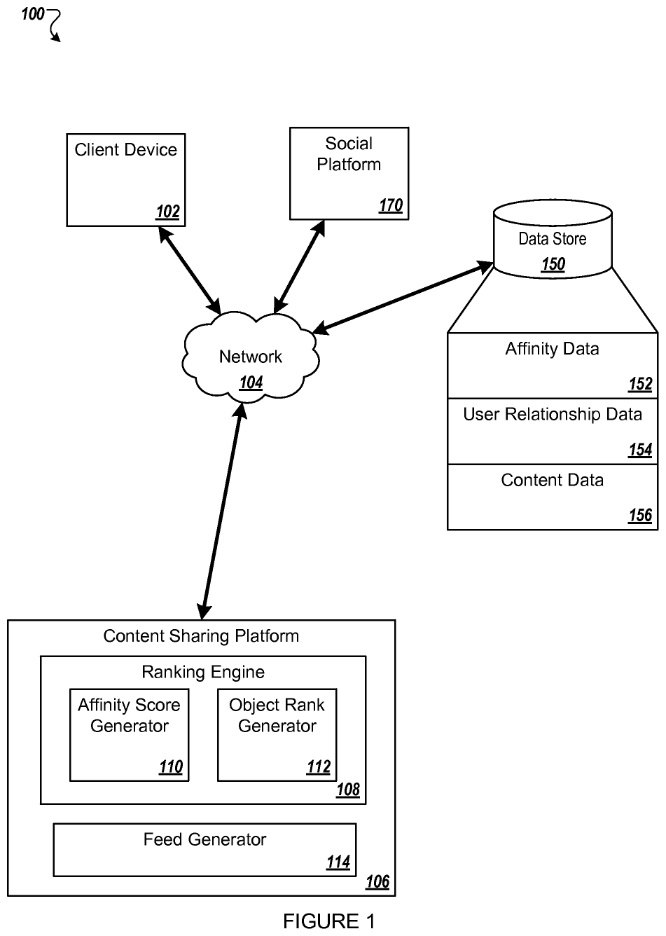

FIG. 1 illustrates an example system architecture 100, in accordance with implementations of the present disclosure. System 100 comprises a client/user device 102 communicably coupled to a content sharing platform 106, a data store 150, and a social platform 170 over a network 104. The network 104 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The client/user device 102 may be any type of computing device, for example, a device including a processor, a computer-readable medium, and a memory. In some implementations, the client/user device 102 may be executing a browser application or other application adapted to communicate over Internet related protocols (e.g., TCP/IP and HTTP) and/or display a user interface. While only a single client/user device 102 is shown in FIG. 1, system 100 may support a large number of concurrent sessions with many client/user devices 102.

The content sharing platform 106 allows users to connect to and share information with each other. The content sharing platform 106 allows users (e.g., content owners) to upload, view, tag, and share content, such as video content, image content, audio content, and so on. A user can share content with users of a social platform 170, who can then comment on the shared content, discover new content, locate updates, share the provided content with their contacts, and otherwise interact with the provided content. Commenting on the shared content may refer to providing annotations or feedback for the shared content, approving (“liking”) the shared content, disapproving (“disliking) the shared content, and so on. The shared content may include content from professional content creators, e.g., movie clips, TV clips, and music videos, as well as content from amateur content creators, e.g., video blogging and short original videos. In some implementations, the shared content is stored as content data 156 in data store 150.

The content sharing platform 106 and the social platform 170 each may include one or more computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine.

The content sharing platform 106 is capable of operating within a single server device or on multiple server devices. For example, although each of the affinity score generator 110, object rank generator 112 and feed generator 114 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

Data store 150 can include one or more writable persistent storage devices, such as memories, tapes or disks. A data store may include, but is not limited to, a table, a database, a directory, a repository, and one or more files, to name a few examples. Data store 150 can include one or more activities that are associated with an object. The activities can be indexed and can be accessed using a key. In implementations, the key is an identifier of the object (e.g., a unique ID).

During operation of system 100, a user (e.g., content owner) may access content sharing platform 106 via client device 102 over network 104. The content sharing platform 106 receives communications from the client device 102, and processes and/or directs these communications accordingly. In one implementation, the content sharing platform 106 includes a processing device and a computer-readable memory.

In one implementation, content sharing platform 106 provides a centralized location for a content owner to showcase content of the content owner. The centralized location can represent a home page of a content owner or a channel of a content owner.

A channel can be content available from a common source (a certain content owner) or content having a common topic or theme. The content can be digital content chosen by a content owner, digital content made available by a content owner, digital content uploaded by a content owner, digital content chosen by a content provider, digital content chosen by a broadcaster, etc.

Users (e.g., fans) can interact with the content of the content owner on the content sharing platform 106 and/or the social platform 170. Different activities can be associated with a fan based on the fan's actions with respect to the content of the content owner. For example, activities can include interactions with the content, such as the fan approving (e.g., liking,) commenting on, sharing the content of the content owner, etc.

The content sharing platform 106 can aggregate objects (e.g., comments, related media items such as video, images, audio, etc., status updates, favorability indications, tags, messages, and so on) resulting from fan activity with respect to the content of the content owner and collect the objects in a feed for the content owner. In one implementation, the feed represents a graphical user interface provided by the content sharing platform 106 that presents one or more objects resulting from fan activity, where the fan activity took place via an external social platform (e.g., social platform 170) and/or the content sharing platform 106. For example, the feed can include a media item (e.g., a video or an image) that a fan shared on the social platform 170 in relation to the content of the content owner.

In implementations, a ranking engine 108 ranks objects in the feed to be presented to the content owner based on, for example, a determined relevance to the content owner. To rank the objects in the activity feed, the ranking engine 108 can include an affinity score generator 110 and an object rank generator 112. Various ranking algorithms may be utilized by ranking engine 108 to generate this ranking of objects.

In one implementation, an input to the ranking algorithm used by ranking engine 108 is an affinity score between the viewing user and a user associated with the viewed object. In one implementation, an affinity score is an indication of a level of connection between two users of the content sharing platform 106. In implementations, the affinity score can indicate a level of interest a fan has with respect to the content owner's content. For example, the affinity score may be calculated by looking at explicit actions that a fan takes in association with the content of the content owner (e.g., clicking, liking (providing a positive feedback), commenting, tagging (e.g., assigning an identifier to a piece of information), sharing, subscribing (e.g., to a channel of the content owner), and factoring in the strength of the action how “interesting” the fan who took the action was to the content owner and/or how “interested” the fan was in the content owner's content. In addition, other factors such as mode of communication of a fan with respect to the content of the content owner, frequency of communications of a fan with respect to the content of the content owner, time since last interaction of a fan with respect to the content of the content owner, and so on, may be taken into consideration for determining an affinity score. An affinity score can also have a time component, such as a time decay that decreases the affinity score over time. That is, the affinity score of a fan can decrease if the fan stops interacting with content of the content owner. Alternatively, the affinity score of a fan can increase as the fan again interacts with content of the content owner. An affinity score may be a one-way score (e.g., not reciprocal). In other words, a first user's affinity score for a second user is not necessarily the same as the second user's affinity score for the first user.

In implementations, when ranking engine 108 receives an object (e.g., a post, a comment, a related media item) of a fan to be ranked for the content owner, the ranking engine 108 first determines the entities (e.g., a fan, a content owner, other viewers of the object) associated with the object. In one implementation, more than one entity may be associated with an object. For example, a fan may re-post an object posted by the content owner. Another example includes a content owner that posts an object and then multiple fans that comment on that same object. In a further example, a fan may share an object on an external social platform 170, to which multiple other users may comment on the object within the external social platform 170. Implementations of the disclosure encompass two or more entities being associated with an object.

After the fans associated with an object are determined, affinity score generator 110 may determine an affinity score between each determined entity/user associated with the object and the content owner. In some implementations, affinity data 152 in data store 150 is referenced to affinity score data maintained for each fan of content of the content owner. For example, affinity data 152 may include a data structure having an entry for each fan, where each entry details an affinity score to the content owner. In implementations, the affinity data 152 includes data from one or more activity logs from one or more sources (e.g., content sharing platform 106, social platform 170, etc.).

In some implementations, the affinity data 152 is updated in a periodic and ongoing basis based on actions (e.g., clicking, liking, commenting, tagging, sharing, adding content to a playlist, liking a playlist, subscribing to a channel, liking a channel, etc.) taken by the fan with respect to the content of the content owner. In some implementations, actions outside of the content sharing platform 106 (such as email communication, telephone communication, text message communication, social networking on social platform 170, etc.) may also be considered for purposes of determining an affinity score between users.

When affinity scores have been determined for each entity/user associated with each object, these affinity scores are passed to object rank generator 112 in order for object rank generator 112 to create an object score for the object for purposes of ranking and placing objects in the content owner's feed. The object score can indicate a predicted interest level of the content owner in an object resulting from the fan's interaction with respect to content of the content owner. Any variety of ranking algorithms, inputs and factors may be implemented by object rank generator 112 to generate an object score using, for example, affinity score between the content owner and the fan, whether the fan has subscribed to a channel of the content owner, a relationship of the content owner and the fan, time, user clustering, etc. The object rank generator 112 can rank the objects such that, when presented in a content owner's feed, the objects are ordered by their object score. For example, objects that the content owner is more likely to interact with (e.g., select, comment on, like/dislike, view, etc.) can have a higher object score. In another example, the object rank generator 112 can predict or suggest which objects the content owner should interact with and generate a higher object score for such objects. In a specific example, a fan actively interacts with a content owner's content. The fan regularly shares, likes and comments on the content owner's content. Because this fan is actively engaged with the content owner's content, objects resulting from the fan's interactions can be scored highly, such that they are ranked above other objects and appear more prominently within a feed for the content owner.

In some implementations, when generating an object score, the object rank generator 112 can reference user relationship data 154 in data store 150 to obtain relationship data maintained for each fan of content of the content owner. For example, relationship data 154 may include a data structure having an entry for each fan, where each entry details a relationship of the fan to the content owner. Example relationships can include one or more of a: familial relationship, friendly relationship, acquaintance, social connection, top fan, etc. The relationship can contribute to the object score. For example, an object with an otherwise low object score can receive a higher score when the content owner's brother interacts with the object.

The object score can also include a time element, such as when the object was first posted, a time between when the object was first posted and when the most recent interaction was identified, a time since the last fan interaction, a time decay, etc. In some implementations, the object rank generator 112 can use time to decrease a value of a particular activity such that older activities have a lesser value than more recent activities. For example, the object rank generator 112 can calculate the object score, and then divide by time passed. In another example, objects appearing within the last 24 hours can receive a multiplier that increases the object score. The time component can also be structured in a tiered structure, where each tier is associated with a different algorithmic operation. A tiered approach might give higher weight to more recent objects or activities. For example, a first tier can be a 5× multiplier for activities within the past two days, a second tier can have a 3× multiplier for activities between the past three to five days and a third tier can have a 0.1× multiplier for activities older than five days.

In implementations, the object score can also include a recommendation element, such as user clustering. When providing recommendations using user clustering techniques, the object rank generator 112 can identify users with similar demographics and then compare what objects each of the users has interacted with. The object rank generator 112 can predict what other fans might interact with a particular object. When the object rank generator 112 predicts that a particular fan of interest to the content owner is likely to interact with the object, based on the user clustering, the object rank generator 112 can score the element higher. In some implementations, the object score can also include sentiment analysis to identify which objects may be more important to the content owner or which type of objects may be effective at engaging fans.

In some implementations, the content owner's actions can influence an object score of an object. For example, an object can have a first score and when the content owner interacts with the object (e.g., replies to a comment), then the object rank generator 112 can change the object score to a second score. The second score can be higher or lower than the first score based on the nature of the content owner interaction (e.g., liking vs. disliking, etc.).

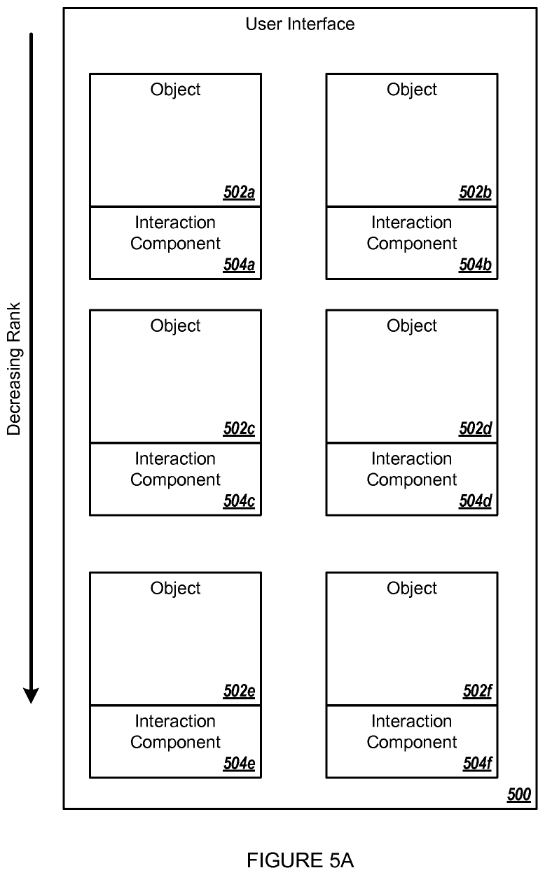

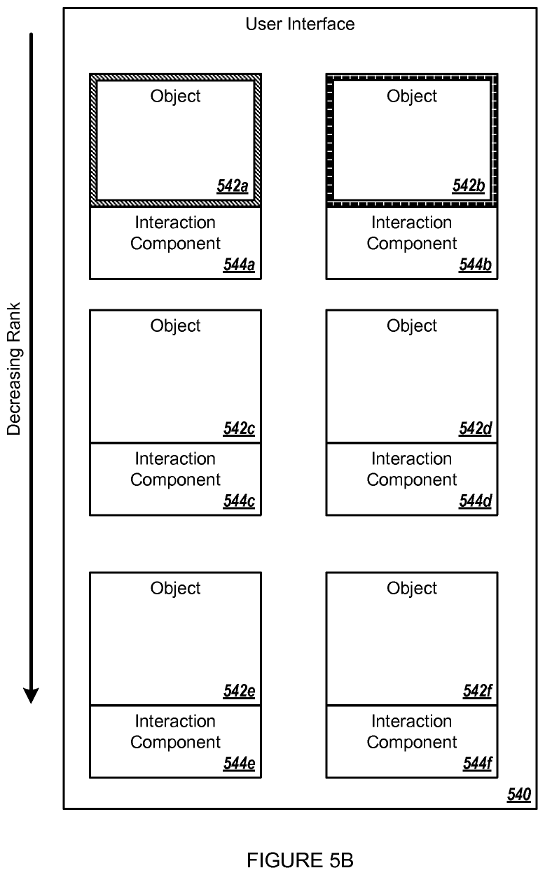

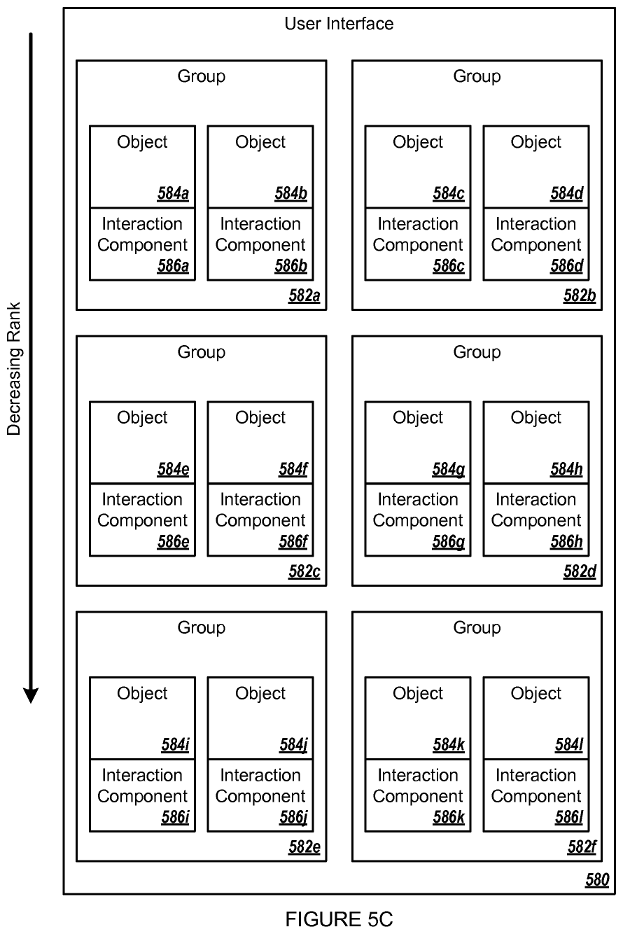

After the object scores have been generated by object rank generator 112, the object scores may be provided to feed generator 114 in order for feed generator 114 to present the objects according to their respective scores in the content owner's feed. In implementations, the feed generator 114 can present various indicators on different objects that can be used to inform the content owner about different aspects of the objects (e.g., highlighting a particular object for the content owner), as described in further detail in conjunction with FIGS. 5A-5C.

In some implementations, the object score may also be used for purposes other than object ranking within a feed, such as selecting a single feed item out of many feed items for display to the content owner, determining if and when a notification should be sent to the content owner, discarding objects from a feed (e.g., if the object rank does not exceed a threshold score).

Although each of content sharing platform 106, social platform 170 and data store 150 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices. Implementations of the disclosure may operate within a single server device or on multiple server devices. Implementations of the disclosure may operate as a standalone system. In some implementations, the content sharing platform 106 and the social platform 170 are managed by a single entity. In some implementations, the content sharing platform 106 and the social platform 170 are managed by different entities.

In situations in which the systems discussed here collect personal information about users, or may make use of personal information, the users may be provided with an opportunity to control whether the content sharing platform 106 collects user information (e.g., information about a user's social network, social actions or activities, profession, a user's preferences, or a user's current location), or to control whether and/or how to receive content from the content sharing platform 106 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 106.

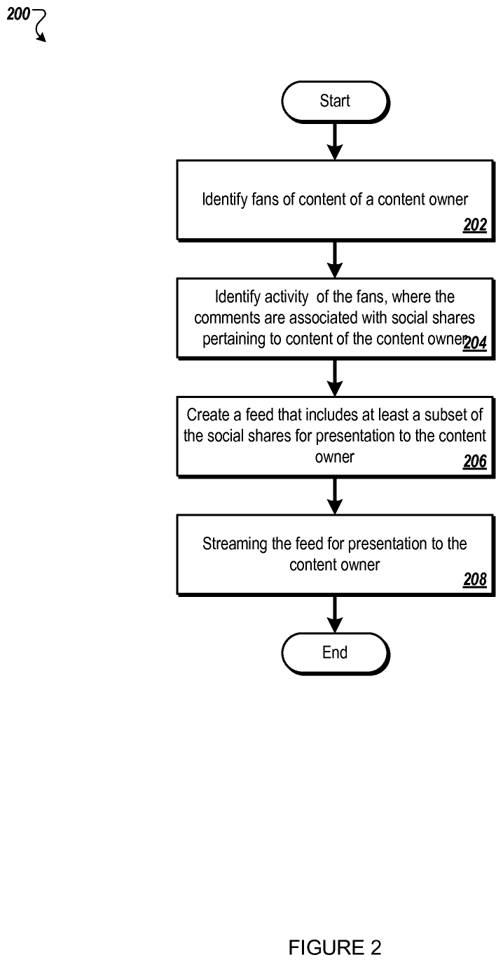

FIGS. 2-4 are flow diagrams illustrating methods associated with a presentation of a feed of objects, according to some implementations of the disclosure. The methods may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Further, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

FIG. 2 is a flow diagram illustrating a method 200 for creating a feed of objects, according to implementations. In one implementation, method 200 may be performed by a content sharing platform, such as the content sharing platform 106, as further described in conjunction with FIG. 1. Method 200 begins at block 202 when processing logic identifies fans of content of a content owner. The fans can be, for example, subscribers to a channel of the content owner. At block 204, the processing logic identifies activities of the fans, where the activities are associated with the content of the content owner. For example, the content can include media items that the content owner has made available to the fans via social shares on a content sharing platform and/or via social platform 170. The activities can include any interactions the fans have with the social shares, such as commenting, liking, sharing, subscribing to, etc. In implementations, the processing logic can identify activities of the fans by accessing one or more log files of a content sharing platform, receiving information from one or more social platforms, etc. to identify activities of the fans in association with the content of the content owner.

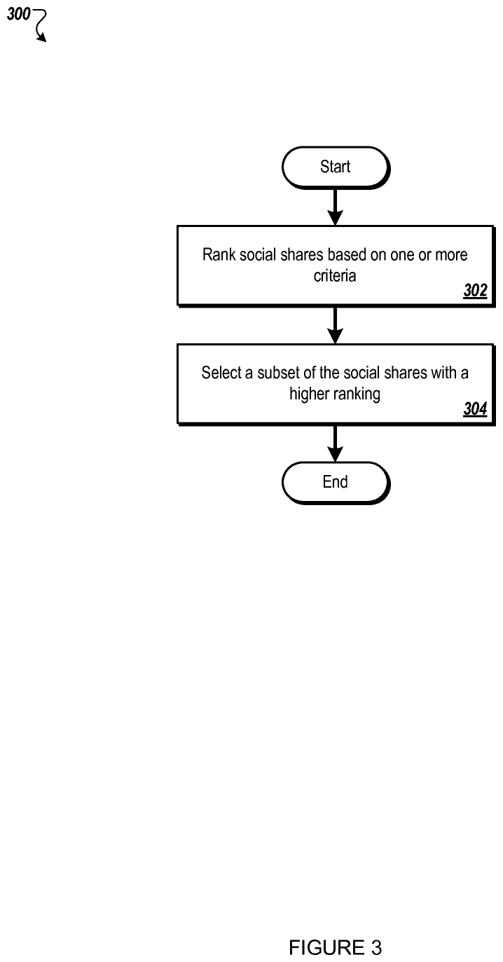

At block 206, the processing logic creates a feed that includes at least a subset of the plurality of objects pertaining to the content of the content owner for presentation to the content owner, where the subset can include two or more objects. As discussed above, an object can result from an action of a fan with respect to the content of the content owner. In some implementations, an object can be included in a social share associated with the content of the content owner. In implementations, when creating the feed including at least a subset of social shares that contain the objects of the fans, the processing logic can create an object score for each object and rank the objects according to their score, as further described in conjunction with FIG. 3. The objects can be presented according to their rank. At block 208, the processing logic can provide (e.g., stream) the feed to a device of the content owner. In implementations, when streaming the feed to the device of the content owner, the processing logic can also provide a recommended action for the content owner for each of the subset of the social shares. The recommended action can include encouraging the content owner to reply to a fan comment.

FIG. 3 is a flow diagram illustrating an example method 300 for ranking objects (e.g., social shares) associated with a content owner. In one implementation, method 300 may be performed by a content sharing platform, such as the content sharing platform 106, as further described in conjunction with FIG. 1.

Method 300 begins at block 302 where processing logic ranks social shares based on one or more criteria. The one or more criteria pertain to activities of the one or more fans in relation to the content of the content owner, where the activities result in objects that may be included in the social shares. The one or more criteria can include an affinity score of each of plurality of fans of a content owner. The affinity score can be based on activities of the respective fan in relation to the content of the content owner, as described herein. The one or more criteria can also include a relationship, a period of time that has elapsed since the fans have interacted with the respective social shares, among others. The processing logic can continually identify activity of the fans and can periodically generate the affinity score for each of the plurality of fans. At block 304, the processing logic selects the subset of the social shares with higher rankings for presentation to the content owner within a feed.

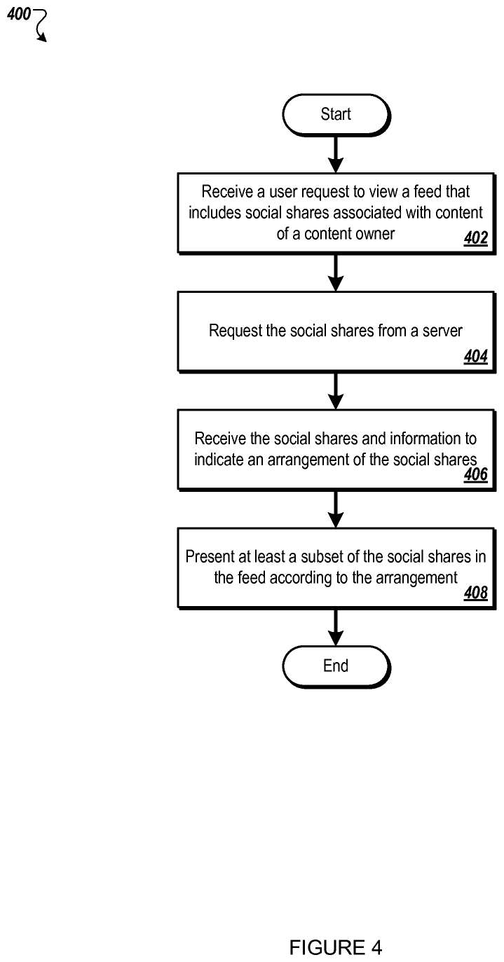

FIG. 4 is a flow diagram illustrating a method 400 for presenting objects on a client device, according to implementations. In one implementation, method 200 may be performed by a client device, such as the client device 102, as further described in conjunction with FIG. 1.

Method 400 begins at block 402 when the processing logic receives a request of a content owner for activities associated with content of the content owner. For example, the request can be input from a content owner to view a feed that includes information about content of the content owner that is included in one or more social shares associated with the content of the content owner. At block 404, the processing logic requests activities information from a server, such as content sharing platform 106 of FIG. 1. At block 406, the processing logic receives, from the server, the activities information that includes social shares containing objects of fans. At block 408, the processing logic presents a feed that includes at least a subset of the social shares to the content owner.

FIGS. 5A-C are example user interfaces 500, 540, 580 in accordance with implementations of the present disclosure. For example, a user can be presented with a user interface 500, 540, 580 when viewing a feed, such as a feed associated with content of a content owner. The user interface 500, 540, 580 can be provided to a content owner via a web browser, an application (e.g., a mobile app), embedded in a third party web page, etc. In implementations, user interfaces 500, 540, 580 may be created and/or presented by a feed generator, such as the feed generator 114, as further described in conjunction with FIG. 1.

In FIG. 5A, the user interface 500 includes a feed that includes multiple objects 502a-f. The objects 502a-f can represent individual objects posted by fans or social shares that are associated with content of the content owner and that include objects posted by fans. For example, a fan can share a video of the content owner in a social network. The shared video, along with any associated comments, can be presented as an object 502 in the form of a social share within the feed. Each of the objects can have an object score and the objects can be presented in the user interface according to the object scores. For example, object score 502a can have a highest object score and thus is presented in the user interface 500 in a prominent position where the content owner is likely to notice. As illustrated, the objects 502a-f can be presented in a decreasing manner, such that the objects with the highest rank are presented on an upper portion of the user interface 500 and objects with the lowest rank are presented on a lower portion of the user interface 500. Any method of organization is contemplated, such as in an increasing order, decreasing order, etc. Object ranking and display can change at any time based on activities of the fans and/or the content owner. For example, when a large number of fans comment and share an object in a short amount of time, an object score for that object can change, which can influences the position of the object on the user interface 500. In a further example, when a content owner interacts with an object (e.g., comments on the object), the object score can change such that the object changes position (e.g., collapse, minimize, move lower down the user interface, on the user interface 500 or is no longer presented in the interface. In implementations, the objects are dynamically reordered in real time. In some implementations, the objects change positions upon a page refresh.

The user interface 500 also can include one or more interaction components 504a-f. As illustrated, each object 502a-f has an associated interaction component 504a-f. The interactions component 504 can present activities of fans and can receive interactions from the content owner. For example, the interactions component 504 can be a comment area or a chat window that facilitates communication between the content owner and the fans of the content.

In FIG. 5B, the user interface 500 includes a feed that includes multiple objects 502a-f (e.g., social shares). The user interface 540 can also include indications on some or all of the objects. As illustrated, object 542a and object 542b include such visual indications (e.g., via color, shape, highlighting, etc.). The indications can notify the content owner of various information pertaining to the object. For example, the indications can inform the content owner that a fan has commented on the object in the time since the content owner last viewed the user interface 540. The indications can also indicate a relationship between a fan who interacted with the object and the content owner. In implementations, the indications are configurable by the content owner. The indication can include anything that could draw the content owner's attention to the object, such as colorings, shadings, patterns, etc. The user interface 500 also can include one or more interaction components 544a-f, as described herein.

In FIG. 5C, the user interface 500 includes a feed that includes multiple objects 502a-1 (e.g., social shares). The user interface 540 can also organize objects 502a-1 into groups 582a-f. The groups can be formed using any criteria, such as by social network, source, relationship of fans to the content owner, time, topic, type of content (e.g., video, music, news article), etc. In implementations, the groups are configurable by the content owner. The user interface 500 also can include one or more interaction components 586a-1, as described herein. In implementations, each group can have an interaction component.

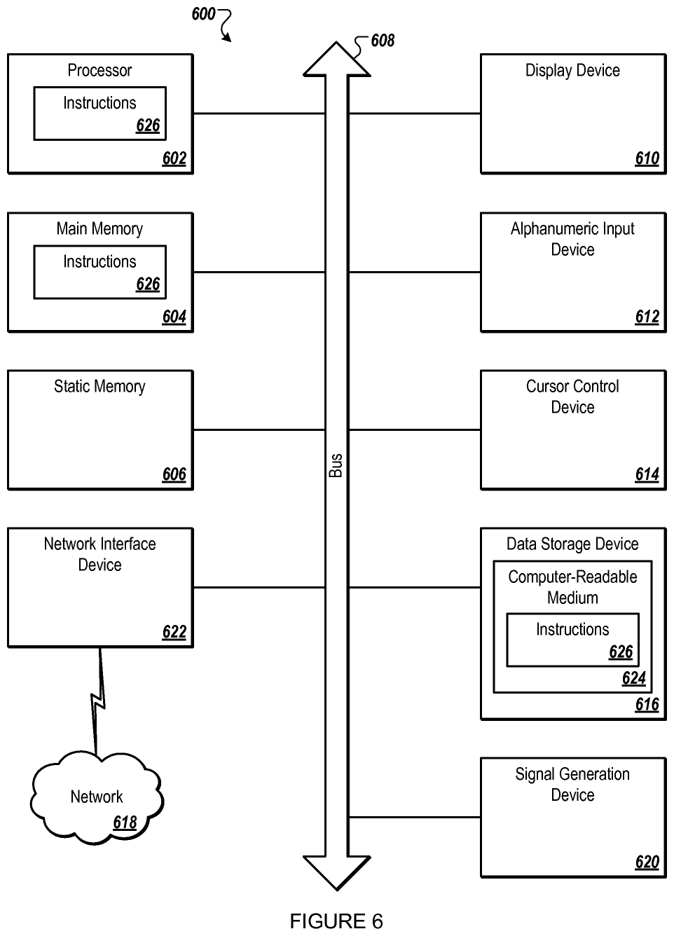

FIG. 6 illustrates a diagrammatic representation of a machine in the example form of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD), a cathode ray tube (CRT), or a touch screen), an alphanumeric input device 612 (e.g., a keyboard), a cursor control device 614 (e.g., a mouse), and a signal generation device 620 (e.g., a speaker).

The data storage device 616 may include a computer-readable storage medium 624 on which is stored one or more sets of instructions 626 (e.g., software) embodying any one or more of the methodologies or functions described herein. The instructions 626 may also reside, completely or at least partially, within the main memory 604 and/or within the processor 602 during execution thereof by the computer system 600, the main memory 604 and the processor 602 also constituting computer-readable storage media. The instructions 626 may further be transmitted or received over a network 618 via the network interface device 622.

In one implementation, the instructions 626 include instructions for an object ranking engine, which may correspond to the ranking engine 108 described with respect to FIG. 1, and/or a software library containing methods that provide a ranking engine. While the computer-readable storage medium 624 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting,” “analyzing,” “determining,” “enabling,” “identifying,” “modifying,” “creating,” “ranking,” “selecting,” “generating,” “streaming,” “accessing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example' or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A method, comprising:
selecting, by a processing device of a first platform from a plurality of users of a plurality of platforms, a plurality of fans of media items of a content owner;
determining, by the processing device of the first platform, activities of the plurality of fans via the plurality of platforms with respect to a plurality of social shares pertaining to the media items of the content owner;
ranking, by the processing device of the first platform, the plurality of social shares based on the determined activities of the plurality of fans;
retrieving, from a data store, user relationship data that indicates a first relationship between a first fan and the content owner and a second relationship between a second fan and the content owner; and
causing, by the processing device of the first platform, a client device of the content owner to display, via a graphical user interface (GUI), a feed comprising:
a first social share resulting from a first type of fan activity of the first fan interacting with a first media item of the content owner via the first platform;
a first visual indication displayed around the first social share, wherein the first visual indication indicates the first relationship between the first fan and the content owner;
a first GUI element associated with the first social share to facilitate a first reply by the content owner to the first type of fan activity of the first fan;
a second social share resulting from a second type of fan activity of the second fan interacting with the first media item of the content owner via a second platform external to the first platform, the first social share and the second social share being selected for the feed based on the ranking;
a second visual indication displayed around the second social share, wherein the second visual indication indicates the second relationship between the second fan and the content owner; and
a second GUI element associated with the second social share to facilitate a second reply by the content owner to the second type of fan activity of the second fan.

2. The method of claim 1 further comprising:
selecting a subset of the social shares with higher rankings, the selected subset comprising the first social share and the second social share; and
creating the feed based on the selected subset.

3. (canceled)

4. The method of claim 1, wherein the ranking comprises determining an affinity score of each of the plurality of fans, wherein the affinity score is based on activities of a respective fan in relation to one or more of the media items of the content owner.

5. The method of claim 4 further comprising periodically generating the affinity score for each of the plurality of fans.

6. The method of claim 1, wherein the ranking comprises determining a period of time that has elapsed since the plurality of fans have interacted with the respective social shares.

7. The method of claim 1 further comprising streaming the feed to the client device of the content owner.

8. The method of claim 7, wherein streaming the feed to the client device of the content owner comprises providing a recommended action for the content owner for each of the first social share and the second social share.

9. The method of claim 1, wherein identifying activities of the plurality of fans comprises accessing a log file of the plurality of platforms to identify activities of the plurality of fans within the plurality of platforms in association with the media items of the content owner.

10. A method comprising:
receiving, by a processing device, a request of a content owner for activities of fans of media items of the content owner, the request being for the activities of fans via a plurality of platforms;
requesting, by the processing device, the activities from a server associated with a first platform of the plurality of platforms;
receiving, by the processing device from the server, a plurality of social shares comprising the activities;
presenting, by the processing device, a feed comprising:
a first social share resulting from a first type of fan activity of a first fan interacting with a first media item of the content owner via the first platform;
a first GUI element associated with the first social share to facilitate a first reply by the content owner to the first type of fan activity of the first fan;
a second social share resulting from a second type of fan activity of a second fan interacting with the first media item of the content owner via a second platform external to the first platform, the first social share and the second social share being selected for the feed based on ranking the plurality of social shares based on the activities; and
a second GUI element associated with the second social share to facilitate a second reply by the content owner to the second type of fan activity of the second fan; and
subsequent to the presenting of the feed, receiving, by the processing device from the server, one or more additional activities;
determining the one or more additional activities are associated with the first social share; and
displaying a visual indication around the first social share in the feed, wherein the visual indication indicates the one or more additional activities associated with the first social share have been received subsequent to the presenting of the feed.

11. A non-transitory computer readable storage medium having instructions that, when executed by a processing device of a first platform, cause the processing device to perform operations comprising:
receiving, from a content owner, user input indicating group configurations for a feed:
selecting, from a plurality of users, a plurality of fans of media items of the content owner;
determining activities of the plurality of fans with respect to a plurality of social shares pertaining to the media items of the content owner;
ranking the plurality of social shares based on the determined activities of the plurality of fans;
determining, based on the user input indicating the group configurations, that a first plurality of social shares comprising a first social share corresponds to a first group and is to be associated with a first visual indication and that a second plurality of social shares comprising a second social share corresponds to a second group and is to be associated with a second visual indication; and
causing, by the processing device of the first platform, a client device of the content owner to display, via a graphical user interface (GUI), the feed comprising:
the first social share resulting from a first type of fan activity of a first fan interacting with a first media item of the content owner via the first platform;
the first visual indication displayed around the first plurality of social shares, wherein the first visual indication is associated with the first group;
a first GUI element associated with the first social share to facilitate a first reply by the content owner to the first type of fan activity of the first fan;
the second social share resulting from a second type of fan activity of a second fan interacting with the first media item of the content owner via a second platform external to the first platform, the first social share and the second social share being selected for the feed based on the ranking;
the second visual indication displayed around the second plurality of social shares, wherein the second visual indication is associated with the second group; and
a second GUI element associated with the second social share to facilitate a second reply by the content owner to the second type of fan activity of the second fan.

12. The non-transitory computer readable storage medium of claim 11, the operations further comprising:
selecting a subset of the social shares with higher rankings, the selected subset comprising the first social share and the second social share; and
creating the feed based on the selected subset.

13. (canceled)

14. The non-transitory computer readable storage medium of claim 11, the operations further comprising streaming the feed to the client device of the content owner.

15. The non-transitory computer readable storage medium of claim 14, wherein streaming the feed to the client device of the content owner comprises providing a recommended action for the content owner for each of the first social share and the second social share.

16. A computing device comprising:
a memory; and
a processing device of a first platform, the processing device being coupled to the memory, wherein the processing device is to:
select, from a plurality of users of a plurality of platforms, a plurality of fans of media items of a content owner;
determine activities of the plurality of fans via the plurality of platforms with respect to a plurality of social shares pertaining to the media items of the content owner;
rank the plurality of social shares based on the determined activities of the plurality of fans;
determine a first plurality of social shares comprising a first social share meets a first criteria and a second plurality of social shares comprising a second social share meets a second criteria; and
cause a client device of the content owner to display, via a graphical user interface (GUI), a feed comprising:
the first social share resulting from a first type of fan activity of a first fan interacting with a first media item of the content owner via the first platform;
a first visual indicator displayed around the first plurality of social shares based on the first plurality of social shares meeting the first criteria;
a first GUI element associated with the first social share to facilitate a first reply by the content owner to the first type of fan activity of the first fan;
the second social share resulting from a second type of fan activity of a second fan interacting with the first media item of the content owner via a second platform external to the first platform, the first social share and the second social share being selected for the feed based on ranking of the plurality of social shares;
a second visual indicator displayed around the second plurality of social shares based on the second plurality of social shares meeting the second criteria; and
a second GUI element associated with the second social share to facilitate a second reply by the content owner to the second type of fan activity of the second fan.

17. The computing device of claim 16, wherein the processing device is further to:
select a subset of the social shares with higher rankings, the selected subset comprising the first social share and the second social share; and
create the feed based on the selected subset.

18. (canceled)

19. The computing device of claim 16, the processing device further to stream the feed to the client device of the content owner.

20. The computing device of claim 16, wherein the processing device is to access a log file of the plurality of platforms to identify activities of the plurality of fans within the plurality of platforms in association with the media items of the content owner.

21. The method of claim 1, wherein the feed comprises, for each of the first social share and the second social share, a corresponding media item of the content owner, a respective determined activity of a respective fan, and a corresponding comment area to facilitate communication between the content owner and the respective fan.

22. The method of claim 1, wherein the ranking of the plurality of social shares is further based on corresponding engagement of each of the plurality of fans with the media items of the content owner.

23. The method of claim 1, wherein, responsive to the causing of the client device to display the feed, the first social share and the second social share are ordered in the feed based on the ranking, wherein, subsequent to causing the client device to display the feed, the method further comprises:
determining additional activities via the plurality of platforms with respect to the plurality of social shares;
determining a predicted interest level of the content owner in the plurality of social shares based on the determined additional activities; and
causing the client device to display, via the GUI, an updated feed comprising the first social share and the second social share reordered in the feed based on the predicted interest level.
